(19) United States
(12) Patent Application Publication
(10) Pub. No.: US 2025/0073653 A1
(43) Pub. Date: Mar. 6, 2025

(54) QUICK DISCONNECT FOR INTERMEDIATE BULK CONTAINER

(71) Applicant: Triad Capital Group, LLC, Columbia Station, OH (US)

(72) Inventors: Philip E. Rankin, Columbia Station, OH (US); Edward R. Schroth, Columbia Station, OH (US)

(21) Appl. No.: 18/821,086

(22) Filed: Aug. 30, 2024

Related U.S. Application Data
(60) Provisional application No. 63/579,681, filed on Aug. 30, 2023.

(51) Int. Cl. B01F 27/806; B65D 77/06

(52) U.S. Cl. CPC B01F 27/806; B65D 77/061

(57) ABSTRACT

One or more techniques and/or systems are disclosed for a mixing assembly. The mixing assembly includes a rigid shaft; an end connection component coupled to a first end of the rigid shaft; and a start connection component coupled to a second end of the rigid shaft opposite to the first end of the rigid shaft. Further, a motor drive is coupled to the start connection component and configured to rotate the start connection component, the rigid shaft, and the end connection component. A collar is arranged between the start connection component and the motor drive. A connector is arranged between the collar and the start connection component. The connector includes threads configured to threadably attach to an opening in an intermediate bulk container for mixing a liquid housed therein.

### CROSS REFERENCE TO RELATED APPLICATIONS

This application claims the benefit of U.S. Provisional Patent Application No. 63/579,681 which was filed with the United States Patent and Trademark Office on Aug. 30, 2023, the entire contents of which is herein incorporated by reference.

### BACKGROUND

### 1. Field

Example embodiments relate to a quick disconnect for intermediate bulk containers.

### 2. Description of the Related Art

Intermediate bulk containers are industrial-sized containers configured to house tens to hundreds to thousands of gallons of liquid material. These intermediate bulk containers are durably designed to withstand stacking and transport via large equipment such as a forklift. The liquid material housed in the containers may need to be mixed as part of its manufacturing process or due to the separation of components in the liquid material over time from storage. To do so, a fluid agitation device may be inserted into an intermediate bulk container to agitate and mix the components of the liquid material to form a homogenous solution.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

In one implementation, a mixing assembly may include a rigid shaft; an end connection component coupled to a first end of the rigid shaft; and a start connection component coupled to a second end of the rigid shaft opposite to the first end of the rigid shaft. Further, a motor drive is coupled to the start connection component and configured to rotate the start connection component, the rigid shaft, and the end connection component. A collar is arranged between the start connection component and the motor drive. A connector is arranged between the collar and the start connection component. The connector includes threads configured to threadably attach to an opening in an intermediate bulk container for mixing a liquid housed therein.

To the accomplishment of the foregoing and related ends, the following description and annexed drawings set forth certain illustrative aspects and implementations. These are indicative of but a few of the various ways in which one or more aspects may be employed. Other aspects, advantages and novel features of the disclosure will become apparent from the following detailed description when considered in conjunction with the annexed drawings.

### BRIEF DESCRIPTION OF THE DRAWINGS

What is disclosed herein may take physical form in certain parts and arrangement of parts, and will be described in detail in this specification and illustrated in the accompanying drawings which form a part hereof and wherein:

FIG. 1 illustrates a partial perspective view of some implementations of an intermediate bulk container with a removable mixing drive assembly as disclosed herein.

FIG. 2 illustrates a side view of some implementations of the removable mixing drive assembly as disclosed herein.

FIGS. 3A, 3B, and 3C illustrate various views of some implementations of an end connection component for a removable mixing drive assembly as disclosed herein.

FIG. 4 illustrates a perspective view of some other implementations of an end connection component for a removable mixing drive as disclosed herein.

FIGS. 5A, 5B, and 5C illustrate various views of some implementations of a start connection component for a removable mixing drive assembly as disclosed herein.

FIGS. 6A and 6B illustrate various views of some implementations of an electric motor drive for a removable mixing drive assembly as disclosed herein.

FIG. 7 illustrates a side view of some implementations of an air-operated motor drive for a removable mixing drive assembly as disclosed herein.

FIG. 8 illustrates a side view of some implementations of a reducer component configured to change the threading size of a removable mixing drive assembly as disclosed herein.

FIG. 9 illustrates a schematic of some implementations of an intermediate bulk container, a removable mixing drive assembly, and a lock component as disclosed herein.

FIGS. 10A and 10B illustrate various views of some implementations of a drum bracket that may receive a removable mixing drive assembly as disclosed herein.

FIGS. 11A, 11B, and 11C illustrate various views of some implementations of an open container C-clamp that may receive a removable mixing drive assembly as disclosed herein.

FIG. 12 illustrates a perspective view of some implementations of a bridge connector that may receive a removable mixing drive assembly as disclosed herein.

FIG. 13 illustrates a perspective view of some implementations of a multi-blade pivot component that may be used with the removable mixing drive assembly as disclosed herein.

FIGS. 14, 15, 16, 17, and 18 illustrate various views of some implementations of a method of inserting, using, and removing a removable mixing drive assembly within an intermediate bulk container for mixing as disclosed herein.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

The disclosed mixing operation and corresponding mixing assembly may be used with intermediate bulk containers in a variety of industries such as agriculture, chemical, container, construction, food and beverage, industrial, manufacturing, coatings, lawncare, oil and gas, personal care, adhesives, polymers, water treatment, and other similar industries. The disclosed mixing assembly provides a portable, low weight, and modular system to, for example, keep a solid within a suspension in a liquid; mix liquids that have separated overtime; use a single mixer across multiple containers of liquid; monitor real-time parameters during mixing; initiate mixing while an operator is not near the container; achieve mixing with only one operator; mix a liquid without high speed shearing; mix within a non-circular container; and interface with a variety of commercially available mixing and container components.

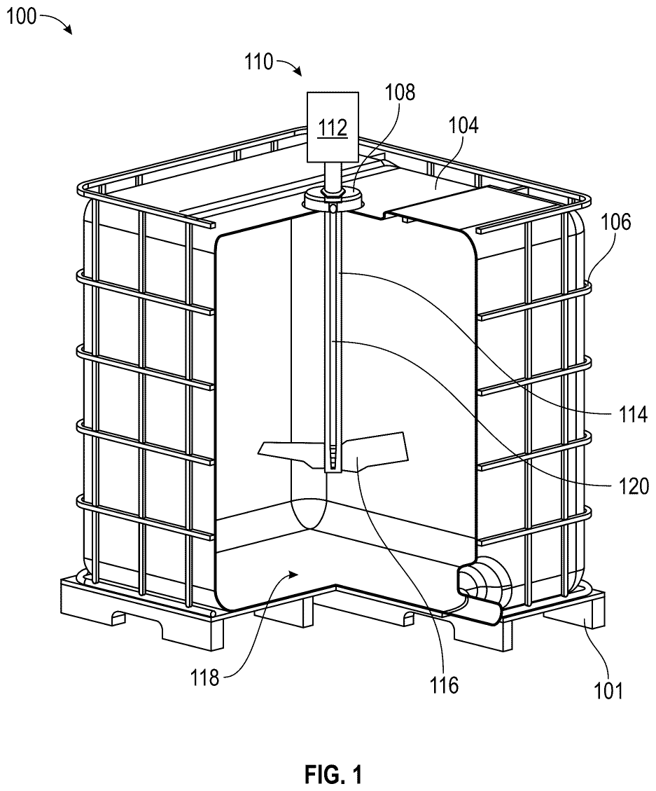

FIG. 1 illustrates a perspective view of some implementations of an intermediate bulk container 100 comprising some implementations of a removable mixing drive assembly 110 as disclosed herein.

The intermediate bulk container (IBC) 100 may comprise a main housing 104 that defines a chamber 118 configured to hold a liquid material (e.g., a solution, a colloid, a slurry, a viscous material, etc.). A portion of the main housing 104 is removed at the front of FIG. 1 such that the chamber 118 and components therein of the IBC 100 can be viewed. It will be appreciated that the main housing 104 would actually be a closed housing and the chamber 118 would not actually be visible in a commercial IBC 100.

To reduce weight and cost, the main housing 104 may comprise a plastic material or some other lightweight metal. To increase the rigidity of the main housing 104, a protective cage structure 106 may be arranged along outer surfaces of the main housing 104. In some implementations, the protective cage structure 106 comprises aluminum, steel, a thermoplastic, a composite, or some other suitable lightweight, rigid, and strong material. The main housing 104 and the protective cage structure 106 are arranged on a pallet 101. In some implementations, the overall shape of the main housing 104, the protective cage structure 106, and the pallet 101 of the IBC 100 may be a rectangular prism for structural and storage purposes.

To access the chamber 118 and enclosed liquid, the main housing 104 may comprise one or more openings. These openings may be plugged during storage and transport and unplugged to access the chamber 118. The openings and plugs on the main housing 104 have a substantially low-profile such that they do not interfere with the stacking of the IBCs 100. To mix the housed liquid in the chamber 118, an agitation device may be inserted into one of the openings in the main housing 104. The agitation device typically does not permanently stay within the IBC 100 due to cost of the agitation device, space and weight constraints of the overall IBC, and maintenance of the agitation device.

As shown in FIG. 1, for example, the IBC 100 comprises a mixing opening 108, which may be a small opening extending through the main housing 104 and configured to receive an agitation device. In some implementations, the agitation device comprises a disposable mixing shaft 114 that is inserted into the mixing opening 108. The disposable mixing shaft 114 may be a hollow tube and comprise blades 116 at a first end of the disposable mixing shaft 114 arranged near a bottom of the IBC 100. In some implementations, the blades 116 may be flexibly attached to the disposable mixing shaft 114 such that the blades 116 flex inwards towards the disposable mixing shaft 114 to fit through the mixing opening 108 and then can laterally flex outwards away from the disposable mixing shaft 114 when in the chamber 118 for efficient mixing. In some implementations, the disposable mixing shaft 114 may comprise several sets of blades 116. The disposable mixing shaft 114 may have a length in a range of between, for example, about 30 inches to about 72 inches. The number of blades 116 coupled to the disposable mixing shaft 114 may increase as the length of the disposable mixing shaft 114 increases. In some implementations, the disposable mixing shaft 114 comprises a lightweight, inexpensive material such as high-density polyethylene or some other suitable plastic such that the disposable mixing shaft 114 is used once and then is discarded. This saves time and cost in cleaning the disposable mixing shaft 114 after its use.

The disposable mixing shaft 114 comprises an opening concentric with the mixing opening 108 of the IBC 100 that is configured to receive a removable mixing drive assembly 110. The disposable mixing shaft 114 separates the removable mixing drive assembly 110 from the liquid in the chamber 118. Thus, the removable mixing drive assembly 110 can be quickly inserted into the IBC 100, can be turned ON to mix the liquid in the IBC 100, can be turned OFF and quickly removed from the IBC 100, and can be inserted into a different disposable mixing shaft 114 in a different IBC without cleaning the removable mixing drive assembly 110.

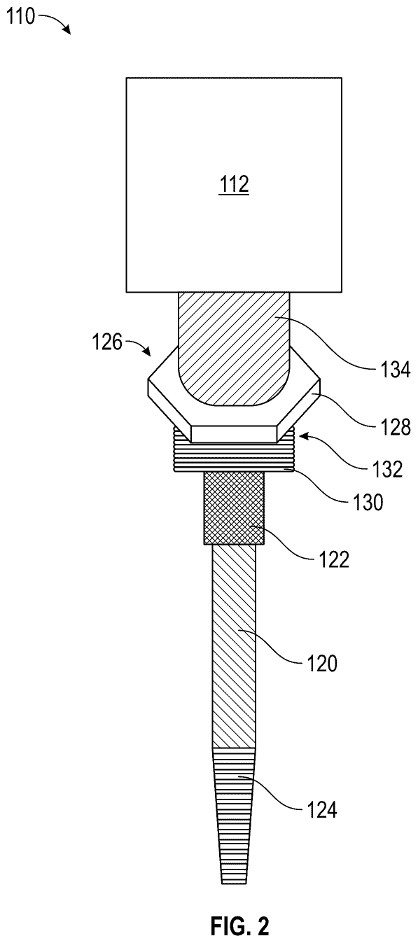

The removable mixing drive assembly 110 comprises a rigid shaft 120 that extends along the length of and within the disposable mixing shaft 114. As will be discussed further herein, the rigid shaft 120 is secured in the disposable mixing shaft 114 near the blades 116. Outside of the chamber 118, the rigid shaft 120 is coupled to a motor drive 112. A quick-disconnect apparatus, which will be discussed further in FIG. 2, reliably and quickly couples the removable mixing drive assembly 110 to the mixing opening. When ON, the motor drive 112 is configured to turn the rigid shaft 120, and the turning of the rigid shaft 120 turns the disposable mixing shaft 114 and blades 116 to agitate the liquid housed in the chamber 118. After mixing is completed, the motor drive 112 may be turned OFF, the quick-connect apparatus may be disconnected from the mixing opening 108, and the removable mixing drive assembly 110 may be removed from the disposable mixing shaft 114 by an operator. The removable mixing drive assembly 110 may be used in a different IBC without cleaning. After removing the removable mixing drive assembly 110, the disposable mixing shaft 114 and corresponding blades 116 may be removed from the IBC 100 and disposed. The IBC 100 may be re-plugged at the mixing opening 108 or the housed liquid may be extracted from the IBC 100 at the mixing opening 108 for its end-use.

Turning now to FIG. 2, the removable mixing drive assembly 110 is illustrated in isolation from the IBC 100. In some implementations, the removable mixing drive assembly 110 comprises an end connection component 124 coupled to a first end of the rigid shaft 120 and a start connection component 122 coupled to a second end of the rigid shaft 120 opposite to the first end of the rigid shaft 120. In some implementations, the rigid shaft 120 is a hexagonal mixing shaft, meaning that a cross-section of the rigid shaft 120 is a hexagon. In some implementations, the rigid shaft 120 may be a 7/16 inch hexagonal mixing shaft, for example. It will be appreciated that the rigid shaft 120 may comprise a different shape and/or size cross-section based on, for example, the design of the disposable mixing shaft 114 such that the disposable mixing shaft 114 can receive the rigid shaft 120. The rigid shaft 120 may be hollow and comprise a lightweight material, such as aluminum or a plastic, to reduce the weight of the rigid shaft 120. The start connection component 122 and the end connection component 124 may each receive the respective ends of the rigid shaft 120, and the start and end connection components 122, 124 may be secured to the rigid shaft 120 via a bracket, a pin, or some other suitable connection structure.

The start connection component 122 may be coupled to the drive connector 134. The drive connector 134 is configured to couple with the mixing opening 108 of the IBC 100. In some implementations, the size of the drive connector 134 is not compatible with the mixing opening 108 of the IBC 100. In some such implementations, a reducer component 126 is coupled to the drive connector 134 such that the reducer component 126 is configured to couple with the mixing opening 108 of the IBC 100. The reducer component 126 may comprise a collar 128 and a connection region 130, wherein the connection region 130 comprises outer threads 132. In some implementations, the collar 128 has a diameter larger than the connection region 130 and larger than the drive connector 134. As will be discussed later herein, the collar 128 is configured to prevent the reducer component 126 from un-screwing from the mixing opening 108 and from the drive connector 134 during a mixing operation by the removable mixing drive assembly 110 in the IBC 100. A motor drive 112 may be arranged over and coupled to the drive connector 134. The motor drive 112 is configured to rotate the rigid shaft 120 and the end connection component 122 to ultimately rotate the disposable mixing shaft 114 and blades 116 within the IBC 100. As will be discussed further herein, the motor drive 112 may be electrically-operated or air-operated.

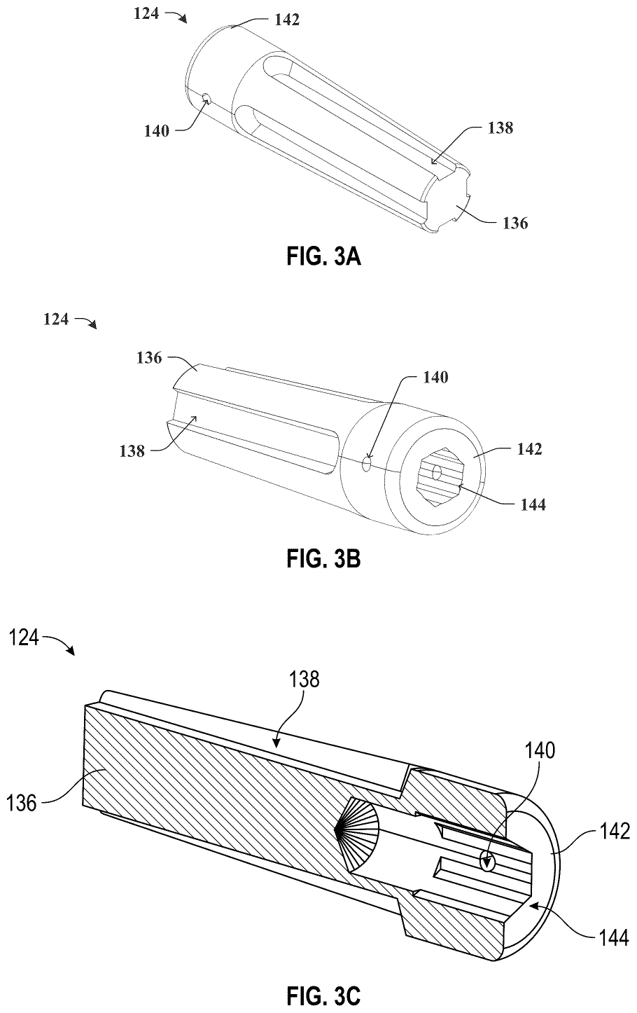

Turning additionally to FIGS. 3A, 3B, and 3C, more detailed views of some implementations of the end connection component 124 of the removable mixing drive assembly 110 are presented. FIGS. 3A and 3B illustrate perspective views of the end connection component 124, and FIG. 3C illustrates a cross-sectional view of the end connection component 124.

The end connection component 124 may comprise a first end 136 that is closed, and a second end 142 that comprises a shaft opening 144. The shaft opening 144 may be sized to receive a first end of the rigid shaft 120. For example, the end connection component 124 in FIGS. 3A, 3B, and 3C may be configured to receive a rigid shaft 120 having a hexagonal cross-section. As such, the shaft opening 144 is shaped as an elongated hexagon. In some implementations, the end connection component 124 may comprise at least one pin opening 140 that extends through an outer sidewall of the end connection component 124 proximate the second end 142 and into the shaft opening 144. The pin opening 140 may be configured to receive a pin or some other suitable connection structure, for example, a set screw, to secure the rigid shaft 120 in the shaft opening 144. In some implementations, the end connection component 124 comprises indentations 138 along its sidewalls proximate the first end 136. These indentations 138 are configured to mate or inter-lock with protrusions within the disposable mixing shaft 114 such that as the end connection component 124 rotates via the rigid shaft 120 and motor drive 112, the end connection component 124 forces the disposable mixing shaft 114 to also rotate. It will be appreciated that the dimensions and shape of the end connection component and the indentations 138 thereof may be retrofitted to the design of the portion of the disposable mixing shaft 114 configured to inter-lock with the end connection component 124 of the removable mixing drive assembly 110. Similarly, the length and diameter of the rigid shaft 120, the type of motor drive 112, the size of the reducer component 126, and other components of the overall removable mixing drive assembly 110 may be retrofitted to other types of IBCs 100, mixing openings 108, disposable mixing shafts 114, and the like.

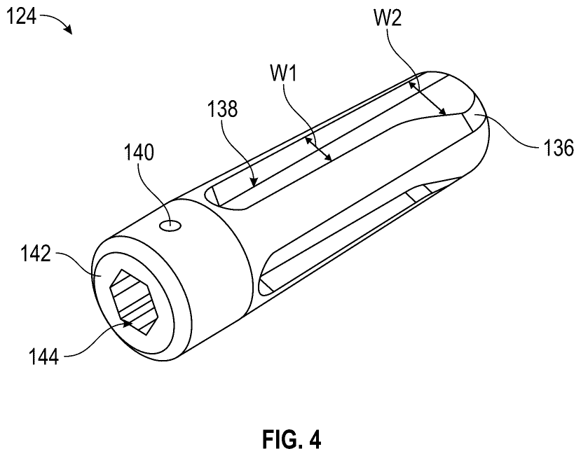

FIG. 4 illustrates a perspective view of some other implementations of the end connection component 124. In some implementations, a width of the indentations 138 may change throughout the length of the indentations 138. In some implementations, for example, each indentation 138 may have a first width w1 arranged at a first distance away from the first end 136 of the end connection component 124. Each indentation 138 may have a second width w2 arranged at a second distance away from the first end 136 of the end connection component 124. The first distance is greater than the second distance, and the first width w1 is less than the second width w2. Thus, the width of the indentation 138 may increase as the width is measured closer to the first end 136 of the end connection component 124. Because of the larger indentations 138 near the first end 136, the end connection component 124 may be easily dropped into the disposable mixing shaft 114 and self-align and engage with protrusions of the disposable mixing shaft 114, thereby reducing the time and effort it takes to connect the end connection component 124 with the disposable mixing shaft 114. Upon engagement, the protrusions of the disposable mixing shaft 114 are more confined by the narrower areas of the indentations (e.g., at the first width w1) to ensure a tight connection between the end connection component 124 with the disposable mixing shaft 114.

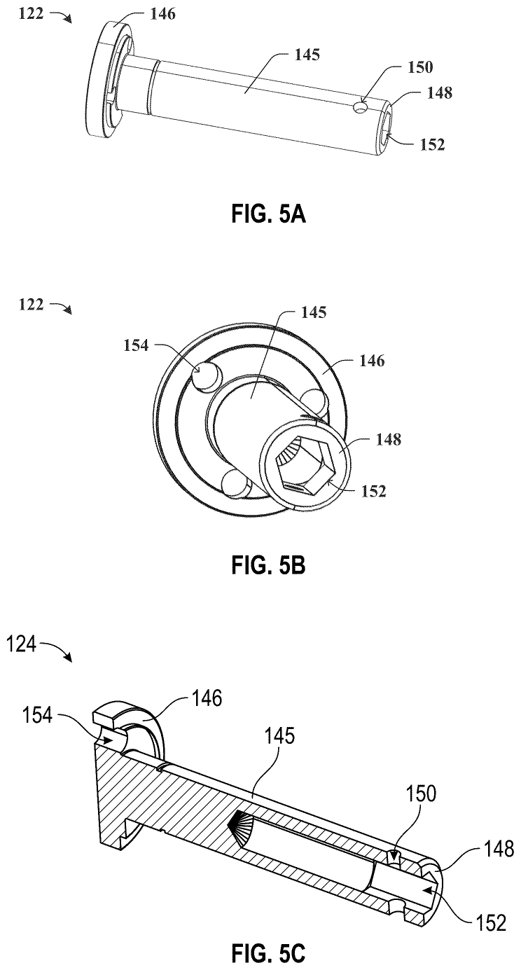

Turning additionally to FIGS. 5A, 5B, and 5C, more detailed views of some implementations of the start connection component 122 of the removable mixing drive assembly 110 are presented. FIGS. 5A and 5B illustrate perspective views of the start connection component 122, and FIG. 5C illustrates a cross-sectional view of the start connection component 122.

The start connection component 122 may comprise an elongated portion 145 and a collar portion 146, wherein the elongated portion 145 protrudes and extends away from a center of the collar portion 146. The start connection component 122 comprises a shaft opening 152 at a first end 148 of the elongated portion 145 opposite to the collar portion 146. Like the shaft opening 144 of the end connection component 124, the shaft opening 152 of the start connection component 122 may be sized to receive a first end of the rigid shaft 120. Further, the elongated portion 145 comprises at least one pin opening 150 that extends through an outer sidewall of the start connection component 122 proximate the first end 148 and into the shaft opening 152. The pin opening 150 may be configured to receive a pin or some other suitable connection structure, for example, a set screw, to secure the rigid shaft 120 in the shaft opening 152. The collar portion 146 of the start connection component 122 may further comprise secure holes 154 configured to receive a connection structure within the motor drive 112 and/or drive connector 134 such that the collar portion 146 is secured at the motor drive 112 and/or drive connector 134, while the elongated portion 145 extends out of the motor drive 112 and/or drive connector 134 such that the rigid shaft 120 may be easily inserted into the shaft opening 152 and connected to the start connection component 122.

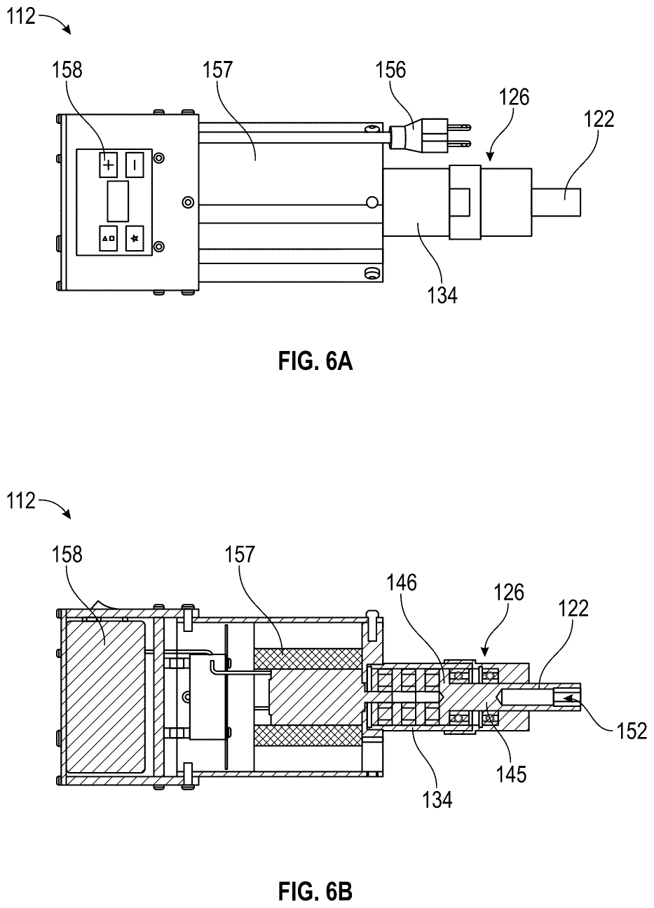

Turning additionally to FIGS. 6A and 6B, in some implementations, the motor drive 112 is an electric motor drive. In FIG. 6A, the electric motor drive 112 comprises a control panel 158 for a user to turn the electric motor drive 112 ON and OFF and to control the rotational speed and pattern of the electric motor drive 112. For example, the control panel 158 may display the RPM, the time remaining in the mixing operation, or some other real-time operating parameter. In some implementations, the motor drives 112 have hall sensors that provide location and speed information for a computer system or some other electronic monitoring device to extrapolate data and give the user feedback data such as speed, resistance, time, centipoise, and the like. The control panel 158 may be directly, wirelessly, and/or remotely controlled. For example, the electric motor drive 112 may be turned ON and OFF by a user in a remote location from the electric motor drive 112 via another computer system, remote control, phone application, or the like that is wirelessly. An electric motor 157 may be coupled to and controlled by the control panel 158. The electric motor 157 and control panel 158 are coupled to and powered by a plug 156. In some other implementations, the electric motor 157 may be battery operated. The drive connector 134 may be coupled the electric motor 157 and to the start connection component 122 such that the rotation of the start connection component 122 is controlled by the electric motor drive 112. The reducer component 126 may be arranged between the start connection component 122 and the drive connector 134. The reducer component 126 may be arranged around at least a portion of the start connection component 122 and at least a portion of the drive connector 134

FIG. 6B illustrates a cross-sectional view of the electric motor drive 112 illustrated in FIG. 6A. As can be seen in FIG. 6B, the collar portion 146 of the start connection component 122 is secured within housing of the drive connector 134. The reducer component 126 fits over the elongated portion 145 of the start connection component 122 and threads into the drive connector 134. The reducer component 126 does not completely cover the elongated portion 145 of the start connection component 122 such that the shaft opening 152 of the start connection component 122 is still easily accessible for connection to the rigid shaft 120.

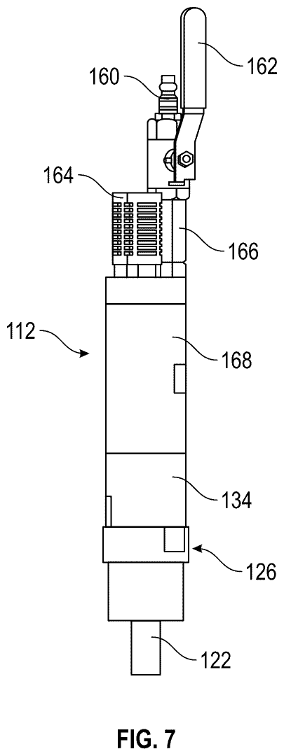

Turning additionally to FIG. 7, in some implementations, the motor drive 112 is an air-operated motor drive. In some such implementations, the air-operated motor drive 112 comprises a same or similar start connection component 122, reducer component 126, drive connector 134 as discussed previously. Thus, the rigid shaft 120 and end connection component 124 can be connected to either the electric motor drive 112 illustrated in FIGS. 6A and 6B, to the air-operated motor drive 112 illustrated in FIG. 7, or to some other suitable motor drive 112. In some implementations, a gear box is also arranged within the drive connector 134, and an air motor 168 is coupled to the drive connector 134 and gear box. An inlet air filter 166 may be arranged over the air motor 168, and an air control valve 162 and air quick connector 160 are coupled to the inlet air filter 166. The air quick connector 160 is configured to connect to a standard air supply hose, and the air control valve 162 can be turned ON and OFF as needed to operate the air motor 168 and ultimately rotate the rigid shaft 120 and disposable mixing shaft 114. In some implementations, the air-operated motor drive 112 may also comprise non-sparking mufflers 164 to reduce noise pollution.

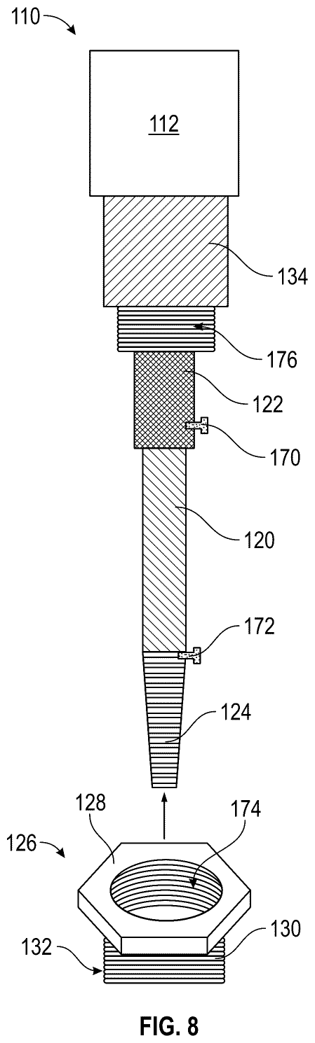

FIG. 8 illustrates yet another schematic of some implementations of the removable mixing drive assembly 110. In some implementations, the reducer component 126 comprises inner threads 174 configured to mate with outer threads 176 of the drive connector 134. The reducer component 126 may be coupled to the drive connector 134 before or after the rigid shaft 120 is coupled to the start connection component 122. Once the reducer component 126 is threaded with the drive connector 134, outer threads 132 of connection region 130 of the reducer component 126 are exposed and ready to couple with the mixing opening 108 of the IBC 100. FIG. 8 further illustrates a first pin 170 (which may be a set screw) coupled to the start connection component 122 to secure the rigid shaft 120 to the start connection component 122, and a second pin 172 (which may be a set screw) coupled to the end connection component 124 to secure the rigid shaft 120 to the end connection component 124.

Thus, the removable mixing drive assembly 110 is modular such that various parts of the removable mixing drive assembly 110 may be adjusted for use with a particular motor drive 110, mixing opening 108, and drive connector 134. For example, it will be appreciated that in some other implementations, the drive connector 134 may already be suitably sized for connection with the mixing opening 108 of the IBC 100. In some such implementations, the reducer component 126 may be omitted.

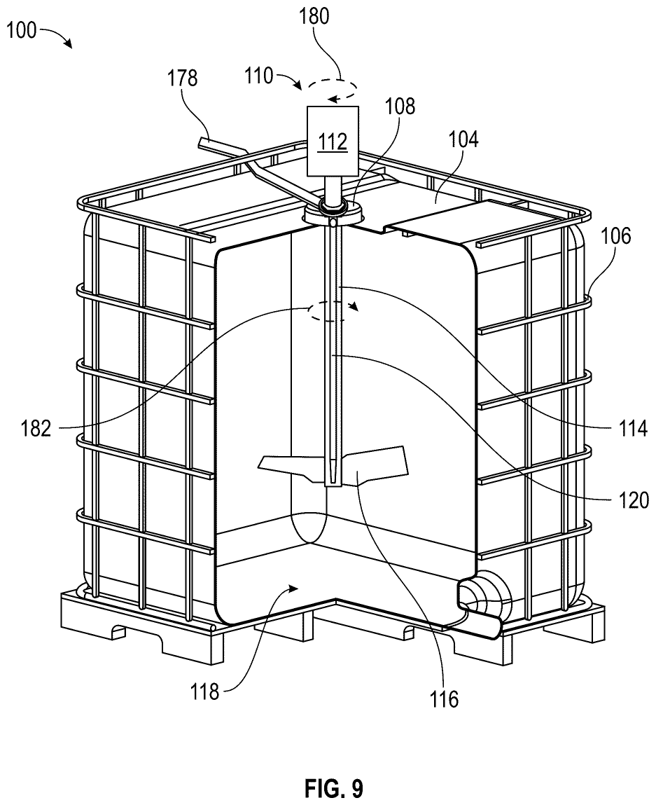

Turning additionally to FIG. 9, when the removable mixing drive assembly 110 is secured in the mixing opening 108, a lock component 178 may be secured to the removable mixing drive assembly 110 to prevent the removable mixing drive assembly 110 from disconnecting from the IBC 100 during a mixing operation. For example, first, the removable mixing drive assembly 110 may be inserted into the mixing opening 108 and within the disposable mixing shaft 114. Then, the outer threads 132 of the reducer component 126 may be screwed into threads of the mixing opening 108 in a counter-clockwise direction 180. The lock component 178 may then rest around the collar 128 of the reducer component 126. The lock component 178 may comprise a long arm that fits between two adjacent rods of the protective cage structure 106 such that the long arm is constricted from movement between the two adjacent rods of the protective cage. This way, the collar 128 of the reducer component 126 is restricted by the lock component 178 and will not un-screw from the mixing opening 108 as the motor drive 112 turns ON and spins the rigid shaft 120, the disposable mixing shaft 114, and the blades 116 in a clockwise direction 182.

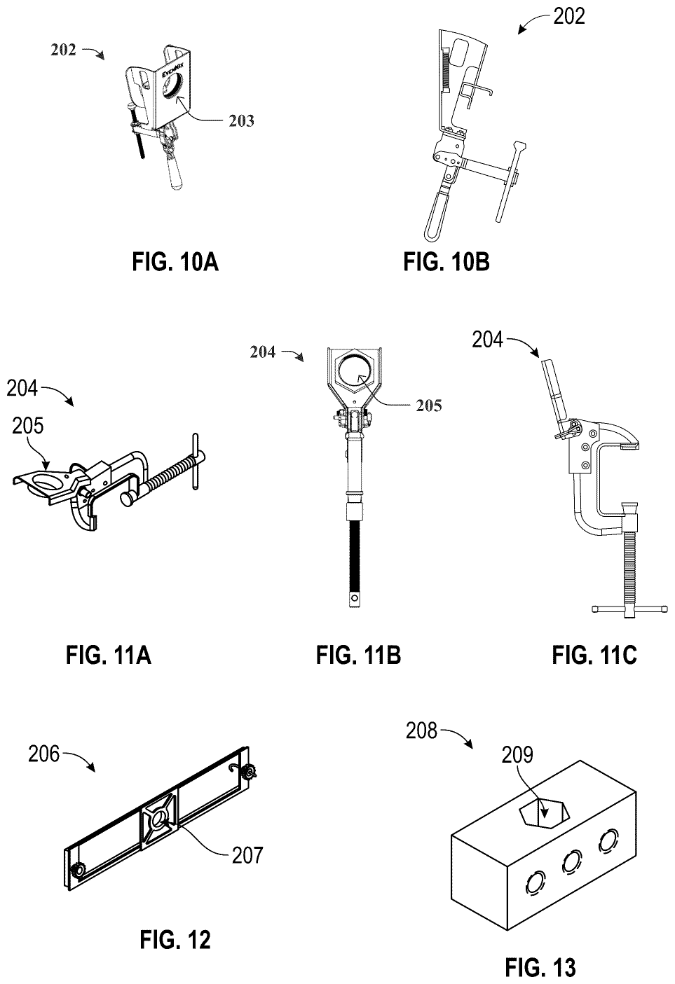

Turning additionally to FIGS. 10A, 10B, 11A, 11B, 11C, 12 and 13, some other devices that may be compatible with the disclosed removable mixing drive assembly 110 are presented. For example, the disclosed removable mixing drive assembly 110 can be used in various different IBCs 100 such as open IBCs, closed IBCs, some other IBC design, drum, container, or the like. As an example, the removable mixing drive assembly 110 may be used to mix the contents held in an IBC housing 275 gallons to 500 gallons; in a drum housing 55 gallons; in an open top container holding 30 gallons to 10,000 gallons; in a closed top container//tank holding 30 gallons to 10,000 gallons; or some other type and sized container.

In FIGS. 10A and 10B, various views of a drum bracket 202 are illustrated. In some implementations, the drive connector 134 or the reducer component 126 may be threaded into an opening 203 of the drum bracket 202. The drum bracket 202 may be connected to an IBC 100 and also may be coupled to the disposable mixing shaft 114 and blades 116 such that the removable mixing drive assembly 110 controls the rotation of the disposable mixing shaft 114 and blades 116. The blades 116 may be inserted into a small opening in the lid of a drum container. In some implementations, for example, the disposable mixing shaft 114 may be flexible enough to fit through a small opening (e.g., as small as 2 inches in diameter) but then the blades 116 flex outwards once within the drum. For example, in some implementations, the blades 116 may span 15 inches in diameter within a 55 gallon drum. It will be appreciated that the blades 116 may be engineered to be larger or smaller depending on the size of the drum and opening.

In FIGS. 11A, 11B, and 11C, various views of an open container C-clamp 204 are illustrated. In some implementations, the drive connector 134 or the reducer component 126 may be threaded into an opening 205 of the open container C-clamp 204. The open container C-clamp 204 may be connected to an IBC 100 and also may be coupled to the disposable mixing shaft 114 and blades 116 such that the removable mixing drive assembly 110 controls the rotation of the disposable mixing shaft 114 and blades 116. In some implementations, the open container that the C-clamp 204 is coupled to may be configured to house about 50 gallons to about 10,000 gallons of liquid. In some implementations, the open container has exposed inner sidewalls during mixing because the open container does not have a lid. The open container C-clamp 204 can accommodate removable mixing drive assemblies 110 having a single folding set of blades 116 or several sets of blades 116.

In FIG. 12, a bridge connector 206 is illustrated. In some implementations, the drive connector 134 or the reducer component 126 may be threaded into an opening 207 of the bridge connector 206. The bridge connector 206 may be connected to an IBC 100 and also may be coupled to the disposable mixing shaft 114 and blades 116 such that the removable mixing drive assembly 110 controls the rotation of the disposable mixing shaft 114 and blades 116. In some implementations, bridge connector 206 is configured to connect to the protective cage structure 106 of an IBC 100. Such a connection provides more support to the bridge connector 206 such that the motor drive 112 can mix thick liquids. Additionally, in some implementations, if the bridge connector 206 is only directly connected to the protective cage structure 106 of the IBC 100, a user may be able to view the liquid being mixed in real-time through the mixing opening 108 of the IBC 100.

In FIG. 13, it will be appreciated that the rigid shaft 120 may be connected to the illustrated pivot block 208. The pivot block 208 comprises a shaft opening 209 configured to receive and couple to the rigid shaft 120, and blade openings configured to receive additional blades. In some implementations, the IBC 100 can have multiple single blades installed and shipped within an IBC 100 via the pivot block 208, where a single motor drive 112 coupled to the pivot block 208 controls the multiple blades at one time. The pivot block 208 allows blade sets to be added, removed, or repositioned anywhere on the rigid shaft 120 of the removable mixing drive assembly 110.

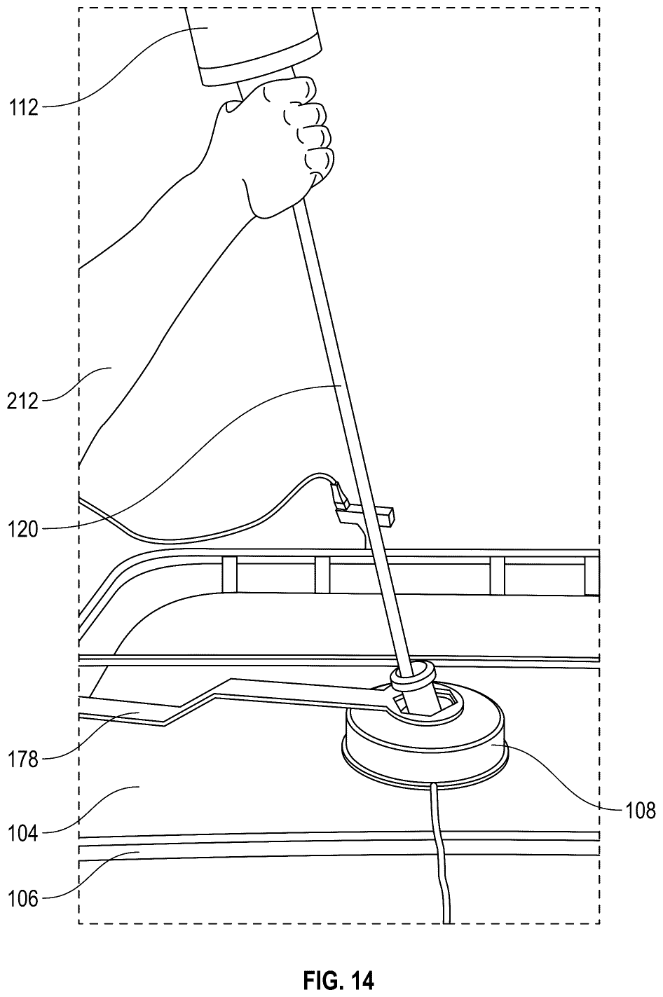

FIGS. 14-18 illustrate various views of some implementations of a method of using some implementations of the removable mixing drive assembly 110 as disclosed herein. It will be appreciated that the steps and order of steps illustrated in FIGS. 14-18 are exemplary and additional steps, a re-arrangement or variation of the order of the illustrated steps as easily obtained by one of ordinary skill in the art are also within the scope of the disclosure.

As shown in FIG. 14, in some implementations, a plug is removed from the mixing opening 108, the lock component 178 is placed over the mixing opening 108, and the removable mixing drive assembly 110 is inserted through an opening of the lock component 178 and through the mixing opening 108. It will be appreciated that prior to the step of FIG. 14, the removable mixing drive assembly 110 may be assembled by connecting the rigid shaft 120 to the start and end connection components 122, 124 and by connecting the reducer component 126 to the drive connector 134. Additionally, it will be appreciated that prior to the step of FIG. 14, the disposable mixing shaft 114 and blades 116 were already inserted and secured to the mixing opening 108 and within the chamber 118 of the IBC 100. Thus, during the insertion step of FIG. 14, the rigid shaft 120 is inserted into the disposable mixing shaft 114, and through a dropping motion, the end connection component 124 self-aligns and engages with protrusions of the disposable mixing shaft 114 near a bottom of the IBC 100.

Because of the lightweight materials used and the overall design of the removable mixing drive assembly 110, the removable mixing drive assembly 110 is portable and thus, can easily be lifted and tightened via a single operator. For example, in FIG. 14, a single operator's hand 212 can move the removable mixing drive assembly 110 into the IBC 100. In some implementations, the removable mixing drive assembly 110, which includes the motor drive 112, may be about 10 pounds to about 20 pounds, which is up to 10 times lighter in weight than some other available mixing drive assemblies. Additionally, the motor drive 112 comprises fairly compact motors that still operate at high speed, which further reduces the weight and size of the removable mixing drive assembly 110 for easy and safe handling by a single operator 212.

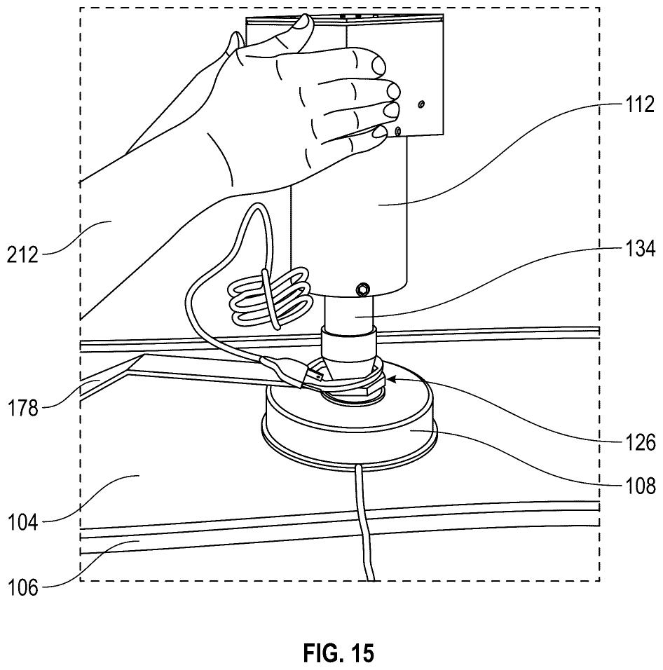

As shown in FIG. 15, the motor drive 112 may be rotated by the single operator 212 to thread the reducer component 126 with the mixing opening 108. During the threading, the lock component 178 is not yet mated with the reducer component 126, thereby allowing the operator 212 to continue to tighten the removable mixing drive assembly 110 in the mixing opening 108. In some implementations, the removable mixing drive assembly 110 is turned in a counter-clockwise direction to engage with the mixing opening 108.

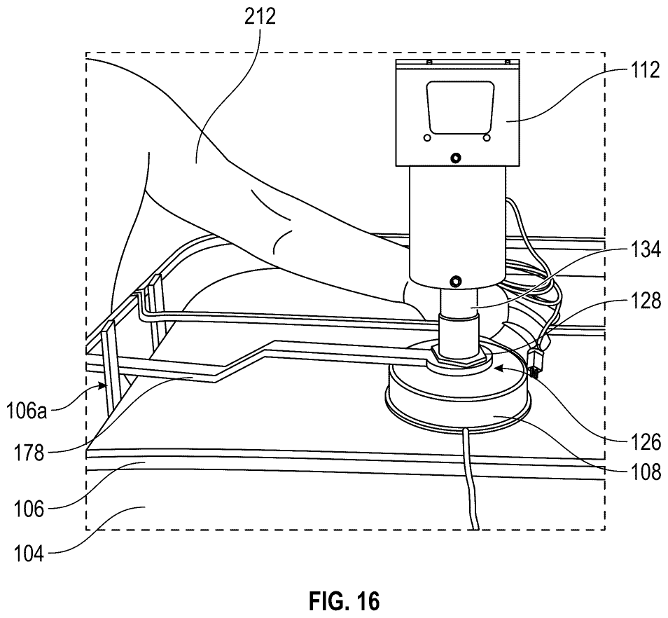

As shown in FIG. 16, the operator 212 lowers the lock component 178 such that an opening of the lock component 178 engages with the collar 128 of the reducer component 126. Further, an end portion of the lock component 178 near outer sidewalls of the IBC 100 is constricted by a frame portion 106a of the protective cage structure 106. This will ensure that the removable mixing drive assembly 110 is secured to the mixing opening 108 and will not un-screw during operation of the removable mixing drive assembly 110. This also allows an operator 212 to tighten the removable mixing drive assembly 110 themselves without the need for an additional tightening machine such as a wrench and excessive force.

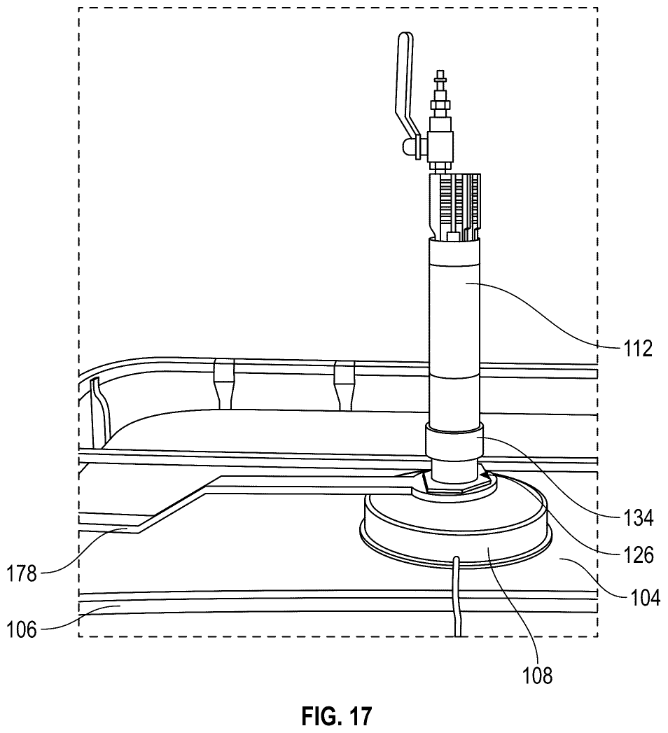

FIG. 17 illustrates some implementations of the removable mixing drive assembly 110 installed in the IBC 100 and ready for a mixing operation. It will be appreciated that the motor drive 112 in FIGS. 14, 15, and 16 is electric, while the motor drive 112 in FIG. 17 is air-operated. Thus, the operator can choose which motor drive 112 is desired. The mixing operation may utilize low velocity circulation of liquids and any solids therein with three dimensional force vectors in the vertical, horizontal, and circumferential directions.

Additionally, because of the high speed motors and compact motor drives 112, less energy is consumed for the mixing operation. In some implementations, these motor drives 112 and corresponding components of the removable mixing drive assembly 110 can be utilized and provide reliable and efficient mixing in IBCs 100 that can hold 5 gallons to up to 10,000 gallons of liquid material, for example. In some other implementations, the IBC 100 may hold about 275 gallons to about 500 gallons, for example. The compact motor drives 112 also result in a higher torque and a low RPM that results in low shear mixing, which reduces energy consumption. For example, in some implementations, the high speed drive motor and high gear ratio reduction is 85 to 1 for the disclosed air-operated motor drives and is 150 to 1 for the disclosed electric motor drives such that the motor drives consume one-third of the energy while also producing 50% more torque compared to other motor drives. Further, in some implementations, the disclosed electric motor drives 112 are DC motors that have a variable speed up to 22,500 RPM and the disclosed air-operated motor drives have a variable speed up to 12,500 RPM. At an 85 to 1 speed drive motor to high gear ratio reduction, the electric motor drive has an optimum mixing speed of up to about 147 RPM, in some implementations. At a 150 to 1 speed drive motor to high gear ratio reduction, the air-operated motor drive has an optimum mixing speed of up to about 150 RPM, in some implementations. The disclosed electric motor drives 112 may each weigh about 5 pounds to about 10 pounds. For example, in some implementations, an electric motor drive 112 weighs about 8 pounds. The disclosed air-operated motor drives 112 may each weigh about 1 pound to about 5 pounds. For example, in some implementations, an air-operated motor drive 112 weighs about 2 pounds. Thus, the electric motor drives 112 and the air-operated motor drives 112 each have a fairly high speed-to-weight ratio, contributing to easy and safe handling of the removable mixing drive assembly 110.

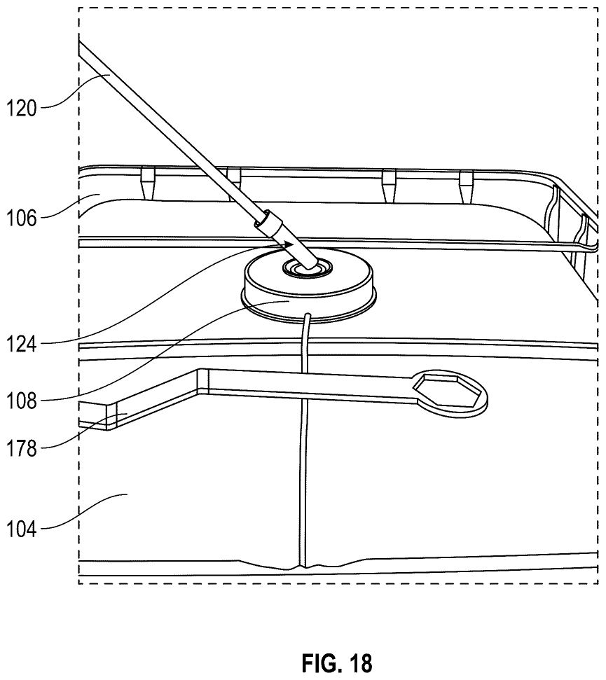

FIG. 18 shows the removable of the removable mixing drive assembly 110 after a mixing operation is concluded. To remove the removable mixing drive assembly 110, the lock component 178 can be lifted up and disengaged from the reducer component 126; the reducer component 126 can be unscrewed from the mixing opening 108; and the entire removable mixing drive assembly 110 is lifted out of the mixing opening 108 by an operator 212. The rigid shaft 120 and end connection component 124 illustrated in FIG. 18 do not have any liquid contamination due to the disposable mixing shaft 114. Thus, the removable mixing drive assembly 110 can quickly be disconnected from the IBC 100 and re-attached to a different IBC without cleaning the removable mixing drive assembly 110. This reduces time, costs, and the number of motor drives 112 needed to mix multiple IBCs 100.

The implementations have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

The word “exemplary” is used herein to mean serving as an example, instance or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Further, at least one of A and B and/or the like generally means A or B or both A and B. In addition, the articles “a” and “an” as used in this application and the appended claims may generally be construed to mean “one or more” unless specified otherwise or clear from context to be directed to a singular form.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Of course, those skilled in the art will recognize many modifications may be made to this configuration without departing from the scope or spirit of the claimed subject matter.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure.

In addition, while a particular feature of the disclosure may have been disclosed with respect to only one of several implementations, such feature may be combined with one or more other features of the other implementations as may be desired and advantageous for any given or particular application. Furthermore, to the extent that the terms “includes,” “having,” “has,” “with,” or variants thereof are used in either the detailed description or the claims, such terms are intended to be inclusive in a manner similar to the term “comprising.”.

What is claimed:

1. A mixing assembly comprising:
a rigid shaft;
an end connection component coupled to a first end of the rigid shaft;
a start connection component coupled to a second end of the rigid shaft opposite to the first end of the rigid shaft;
a motor drive coupled to the start connection component and configured to rotate the start connection component, the rigid shaft, and the end connection component; and
a connector around at least a portion of the start connection component, the connector configured to attach to a mixing opening in an intermediate bulk container for mixing a liquid housed therein.

2. The mixing assembly of claim 1, wherein the connector includes threads configured to threadably attach to threads of the mixing opening in the intermediate bulk container.

3. The mixing assembly of claim 1, further comprising a reducer component configured to attach to the connector and the mixing opening in the intermediate bulk container.

4. The mixing assembly of claim 3, wherein the reducer component comprises inner threads configured to threadably attach to threads of the connector outer threads configured to threadably attach to threads of the mixing opening in the intermediate bulk container.

5. The mixing assembly of claim 1, wherein the rigid shaft is selectably coupled to the end connection component and to the start connection component.

6. The mixing assembly of claim 3, wherein the reducer component has a collar wider than the start connection component.

7. The mixing assembly of claim 1, further comprising:
a reducer component configured to attach to the connector and the mixing opening in the intermediate bulk container, wherein the reducer component includes a collar configured to receive a lock component, and wherein when the collar is engaged with the lock component, the reducer component is unable to rotate.

8. The mixing assembly of claim 1, wherein the end connection component comprises an elongated body, wherein a first end of the elongated body comprises an opening configured to receive a rod, wherein the end connection component comprises indentations extending along the elongated body and towards a second end of the elongated body, and wherein the indentations are configured to receive and mate with protrusions of another component.

9. The mixing assembly of claim 8, wherein each indentation has a varying width, and wherein each indentation has a maximum width closer to the second end of the elongated body than to the first end of the elongated body.

10. The mixing assembly of claim 1, wherein the motor drive is battery powered.

11. The mixing assembly of claim 1, wherein the motor drive is configured to be remotely controlled by an end user.

12. The mixing assembly of claim 1, wherein the motor drive comprises a control panel configured to electrically display real-time operating parameters of the motor drive.

13. The mixing assembly of claim 1, wherein the motor drive is an electric motor drive having a variable speed up to 22,500 RPM and weighs about 5 to 10 pounds.

14. The mixing assembly of claim 1, wherein the motor drive is an air-operated motor drive having a variable speed up to 12,500 RPM and weighs about 1 to 5 pounds.

15. An intermediate bulk container comprising:
a main housing defining a chamber configured to contain a liquid material;
a mixing opening extending through the main housing to access the chamber; a disposable mixing shaft arranged within the mixing opening and extending into the chamber; and
the mixing assembly according to claim 1, wherein the rigid shaft, the end connection component, and the start connection component are arranged within a channel of the disposable mixing shaft, and wherein the motor drive is arranged above the mixing opening and outside of the chamber.

16. The intermediate bulk container of claim 15, wherein the mixing assembly further includes a reducer component attached to the connector and the mixing opening in the intermediate bulk container and wherein the reducer component includes a collar configured to receive a lock component, and wherein when the collar is engaged with the lock component, the reducer component is unable to rotate.

17. The intermediate bulk container of claim 15, wherein the reducer is arranged between the connector and the mixing opening and wherein the reducer component includes inner threads threadably attached to threads of the connector outer threads threadably attached to threads of the mixing opening.
